(19) United States
(12) Patent Application Publication
(10) Pub. No.: US 2015/0293496 A1
(43) Pub. Date: Oct. 15, 2015

(54) FAST BAND PASS HOLOGRAPHIC POLYMER DISPERSED LIQUID CRYSTAL

(71) Applicants: Adam Kent FONTECCHIO, (US); Drexel University, Philadelphia, PA (US)

(72) Inventor: Adam Kent Fontecchio, Downingtown, PA (US)

(73) Assignee: Drexel University, Philadelphia, PA (US)

(21) Appl. No.: 14/439,538

(22) PCT Filed: Oct. 29, 2013
(86) PCT No.: PCT/US13/67254

§ 371 Date: Apr. 29, 2015

Related U.S. Application Data
(60) Provisional application No. 61/719,565, filed on Oct. 29, 2012.

(51) Int. Cl. G03H 1/02; G03H 1/04

(52) U.S. Cl. CPC G03H 1/02; G03H 1/04

(57) ABSTRACT

A hyperspectral holographic polymer dispersed liquid crystal (HPDLC) medium comprising broadband reflective properties comprises dopants that result in a hyperspectral HPDLC with fast transitional switching speeds. A technique for fabrication of hyperspectral broadband HPDLC mediums involves dynamic variation of the holography setup during HPDLC formation, enabling the broadening of the HPDLC medium's wavelength response. Dopants may include carbon nanoparticles, piezoelectric nanoparticles, multiwalled carbon nanotubes, a high dielectric anisotropy compound, semiconductor nanoparticles, electrically conductive nanoparticles, metallic nanoparticles, or the like. The hyperspectral HPDLC having fast switching speeds may be used to form a mirror stack with electrically-switchable beam steering capability.

### CROSS-REFERENCE TO RELATED APPLICATIONS

The instant application claims priority to U.S. Provisional Patent Application No. 61/719,565, entitled “Fast Band Pass Holographic Polymer Dispersed Liquid Crystal,” filed Oct. 29, 2012, which is hereby incorporated by reference in its entirety.

### TECHNICAL FIELD

The technical field generally is related to holographic polymer dispersed liquid crystals (HPDLCs), and more specifically related to a holographic polymer dispersed liquid crystal (HPDLC) medium having fast switching speeds.

### BACKGROUND

Known devices using holographic polymer dispersed liquid crystal (HPDLC) mediums lack the switching speed required to effectively acquire and spectrally multiplex hyperspectral imaging data.

### SUMMARY

High speed switching of optical states of holographic polymer dispersed liquid crystals (HPDLCs) may be achieved by using dielectric dopants. Example dielectric dopants may include carbon nanoparticles, piezoelectric nanoparticles, multiwalled carbon nanotubes, a high dielectric anisotropy compound, semiconductor nanoparticles, electrically conductive nanoparticles, metallic nanoparticles, or the like, or any appropriate combination thereof. Improved switching speeds on the order of 10 to 100 times faster than currently knows switching speeds may be obtainable. Applications of the herein described high speed HPDLCs may include laser switching for light detection and ranging (LIDAR), active band blocking filters, active bandpass filters, or the like, or any appropriate combination thereof.

### BRIEF DESCRIPTION OF THE DRAWINGS

In the drawings, like reference numerals designate corresponding parts throughout the several views.

FIG. 1 and FIG. 2 illustrate an example holographic polymer dispersed liquid crystal (HPDLC) thin film (not to scale) containing phase separated compositions formed under holographic conditions.

FIG. 3 is a graph of example estimated rise and fall times of a HPDLC at different applied voltages and for various droplet sizes.

FIG. 4 illustrates an example transmission spectra of HPDLC reflection gratings with various concentrations of MWNT.

FIG. 5 illustrates plots depicting example changes in capacitance and resistivity of the HPDLC reflection gratings with MWNT at a driving frequency of 1 kHz.

FIG. 6 is a schematic depicting an example applied electric field across an isolated LC droplet in a polymer matrix.

FIG. 7 is a schematic depicting an example applied electric field across an isolated LC droplet in a polymer matrix in the presence of MWNT enhancing the local electric field across the LC droplet.

FIG. 8 illustrates example transmission as a function of applied voltage plots for various concentrations of MWNT.

FIG. 9 illustrates example rise and fall time measurements of HPDLC reflection gratings with various concentrations of MWNT.

FIG. 10 is a chart depicting various example characteristics of a Holographic Optical Element (HOE) comprising a high switching speed HPDLC as described herein.

FIG. 11 depicts an example holography apparatus used in the formation of hyperspectral broadband HPDLC mediums having fast switching speeds as disclosed herein.

FIG. 12 comprising FIG. 12A and FIG. 12B depict an example technique for dynamically varying a holography apparatus during formation to broaden the interaction wavelength of an HPDLC medium via simultaneous time and spatial, or angular, multiplexing.

FIG. 13, which includes FIG. 13A and FIG. 13B, illustrates an example of broadened peak reflective characteristics achievable in an HPDLC medium through the creation of multiple reflections gratings using the techniques disclosed herein, in comparison to peak reflective characteristics of a typical single grating HPDLC medium.

FIG. 14, which includes FIG. 14A and FIG. 14B, depicts SEM micrograph images of a single wavelength reflecting and broadband wavelength reflecting HPDLC mediums respectively.

FIG. 15, which includes FIG. 15A and FIG. 15B, depicts an example of theoretical modeling of a broadband HPDLC medium using Berreman's 4×4 matrix technique.

FIG. 16 and FIG. 17 depict two example methods of creating spherically expanded laser beams.

FIG. 18 depicts an example apparatus comprising an electrically-switched thin-film polymeric mirror stack 802.

### DETAILED DESCRIPTION

Holographically-formed Polymer Dispersed Liquid Crystals (HPDLCs) may comprise stratified layers of liquid crystal droplets contained in a polymer binder. They may be formed holographically, and therefore may be capable of forming a wavelength-specific reflective Bragg grating. The reflection from this grating may be electrically controlled by applying an electric field across the film and thereby rotating the liquid crystal droplets to essentially ‘wipe out’ the grating structure, causing the film to become transparent. The process may be fully reversible. Thus, the HPDLC may revert to its reflecting state once the electric field is removed. The speed at which the HPDLC can switch between states is referred to herein as the switching speed.

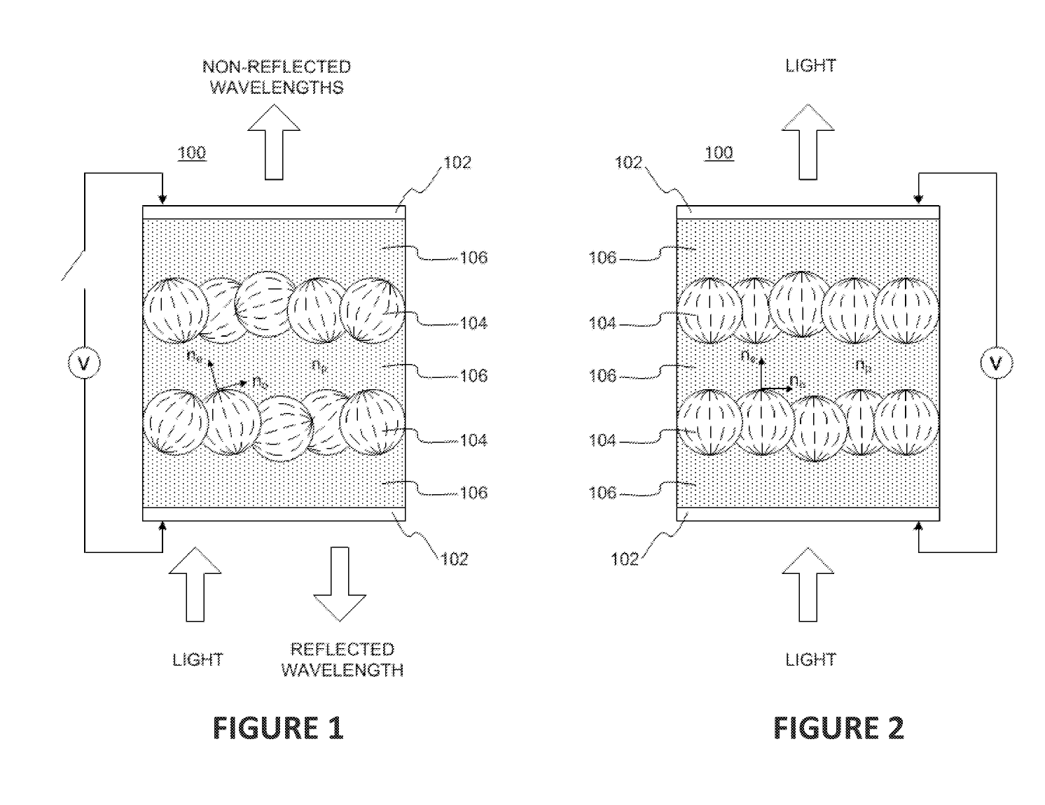

FIG. 1 and FIG. 2 illustrate an example holographic polymer dispersed liquid crystal (HPDLC) thin film 100 (not to scale) containing phase separated compositions formed under holographic conditions. The film may comprise a pre-polymer mixture made up of low molecular weight liquid crystals and a photo-curable monomer. An initiator(s) may be added to sensitize the pre-polymer mixture to a particular wavelength of laser light that will be used during the formation process. A layer of the pre-polymer mixture may be placed between AR-ITO coated glass substrates 102 spaced, for example, 5 μm apart.

In an example formation process the pre-polymer mixture may be irradiated with one or more holographic interference patterns generated by one or more laser light beams. The holographic interference patterns produce high-light-intensity, or bright, regions and dark regions in the pre-polymer mixture. Irradiation of the pre-polymer mixture initiates polymerization of the monomer, which in turn induces a phase separation between the polymer and liquid crystals. The rate of polymerization may be approximately proportional to the square root of the light intensity for one-photon polymerization. Therefore, the rate of polymerization may be spatially dependent. During irradiation the monomer diffuses to the bright regions where it polymerizes. The liquid crystal remains in the dark regions and phase separates into small droplets in ordered, stratified layers. Polymer gelation locks the modulated structure indefinitely, resulting in liquid crystal droplet-rich areas where the dark fringes were, and essentially pure polymer regions where the light fringes were. As a result, a periodic array of liquid crystal droplets 104 and matrix polymer planes 106 may be produced, as shown in FIG. 1 and FIG. 2. The index modulation between the liquid crystal and polymer planes may be estimated from the index of refraction of the individual components. It should be noted that FIG. 1 and FIG. 2 are not to scale, that the number of layers of liquid crystal droplets and polymer depicted therein are merely examples, and that the scope of the instant disclosure should not be limited thereto. The reflection gratings formed may be post-cured with a UV blanket for an interval, for example 10 minutes, to react to any unreacted monomers in the HPDLC medium.

The repeating layers of polymer and liquid crystals may comprise Bragg gratings. A Bragg grating typically reflects a narrow peak wavelength of light. The grating pitch, which is the width of one adjacent polymer and liquid crystal layer, may be determined by the following equation

$$Λ = \frac{λ}{2 n Sin θ} ,$$

where λ is the wavelength of the incident laser light, n is the effective refractive index of the polymer and liquid crystal composite, and θ is the angle with respect to the grating at which each of the laser beams is made incident on the pre-polymer mixture. The reflected Bragg peak wavelength, which can also be determined from the above equation, is directly proportional to the grating pitch. Accordingly, to create broadband reflecting gratings, the angle of incidence of the counter propagating beams may be taken into consideration in deciding the reflected wavelength of the HPDLC.

An electric field may be applied across a HPDLC medium to control the intensity of the wavelength of light reflected from the HPDLC. An electric field may transform the HPDLC from a wavelength selective device to an optically transparent state, as depicted in FIG. 2. Thus, if no field is applied, as depicted in FIG. 1, the HPDLC will reflect light at specific wavelengths corresponding to the Bragg grating(s) present in the HPDLC. When an electric field is applied, the liquid crystals in the HPDLC may align with the direction of the field, making the HPDLC effectively transparent and allowing light to travel through the HPDLC medium. HPDLC mediums have a narrow peak reflection wavelength with a full width at half maximum (FWHM) varying typically from 5 to 20 nm and based on the thickness of the Bragg grating.

In an example embodiment, the liquid crystals may be made of dielectric nematic liquid crystals, which orient in the direction of an external electric field applied to the HPDLC. The refractive index of nematic liquid crystal along the optic axis is called the extraordinary refractive index, represented as nₑ, and the refractive index perpendicular to it is called the ordinary refractive index, represented as nₒ.

In an example HPDLC medium, in which the liquid crystal and polymer planes are oriented approximately parallel to the substrates, the operation of the Bragg gratings, serving as reflection gratings, may be governed by the Bragg condition

λ=2 [symbol] n [symbol] d

for normal incidence. Here, d is the layer thickness and <n> is the average refractive index of the grating which can be approximated by

[symbol]

n [symbol] ≈φ_{P}n_{P}+φ_{LC}n_{LC}

where φ_{P} and φ_{LC} are the volume fraction of the polymer and liquid crystal, respectively, and the average index of the liquid crystal may be given by

$${n}_{LC} = \sqrt{\frac{2 {n}_{o}^{2} + {n}_{e}^{2}}{3}} .$$

A large refractive index modulation between the liquid crystal rich planes and the surrounding polymer planes may likely yield high diffraction/reflection efficiency and low residual scattering when no field is applied. If the ordinary refractive index of the liquid crystal, nₒ, matches the refractive index of the polymer, nₚ, the HPDLC medium may revert to a transparent state (with the material optically homogeneous) upon the application of an electric field, as depicted in FIG. 2.

Holographic polymer dispersed liquid crystals (HPDLCs) may be characterized as electro-optic thin film devices which, upon application of an electric field, may be switched between a diffracting and a transmissive state. The grating pitch may be determined by the interference pattern generated by the recording laser beams. Applying a higher voltage to an HPDLC may increase switching speed, but the HPDLC may suffer damage due to the higher voltage.

As described herein, switching speed may be increased without necessarily increasing applied voltages. A fabrication method which may reduce the switching voltage needed to be applied to an HPDLC and further may improve switching speed of an HPDLC may include doping the HPDLC with a material that may reduce the in liquid crystal droplet size. The reduced droplet size may result in a change in the dielectric properties of the HPDLC. The liquid crystal droplet size may be in a range of 300 nanometers to 5 micrometers. In an example configuration, applying voltage of less than or equal to 400 volts on the hyperspectral holographic polymer dispersed liquid crystal medium may exhibit a switching speed from a reflective state to a transparent state of about 15 microseconds and a switching speed from a transparent state to a reflective state of 100 nanoseconds.

As described herein, depending upon the material composition and the applied voltage, HPDLCs may exhibit faster on time (the time it takes the HPDLC film to switch optical characteristics of the no-filed applied state to the field applied state) on the order of nanoseconds, and may exhibit faster off time (the time it takes the HPDLC film to switch optical characteristics of the field-applied state to the no-field-applied state) on the order of nanoseconds. In an example embodiment, the on time may be controlled and made faster to reach nanosecond switching times by controlling the size of the LC droplets formed, applied voltage, and the dielectric anisotropy of the liquid crystal (LC) and/or liquid crystal droplets. This also may lead to microsecond off times.

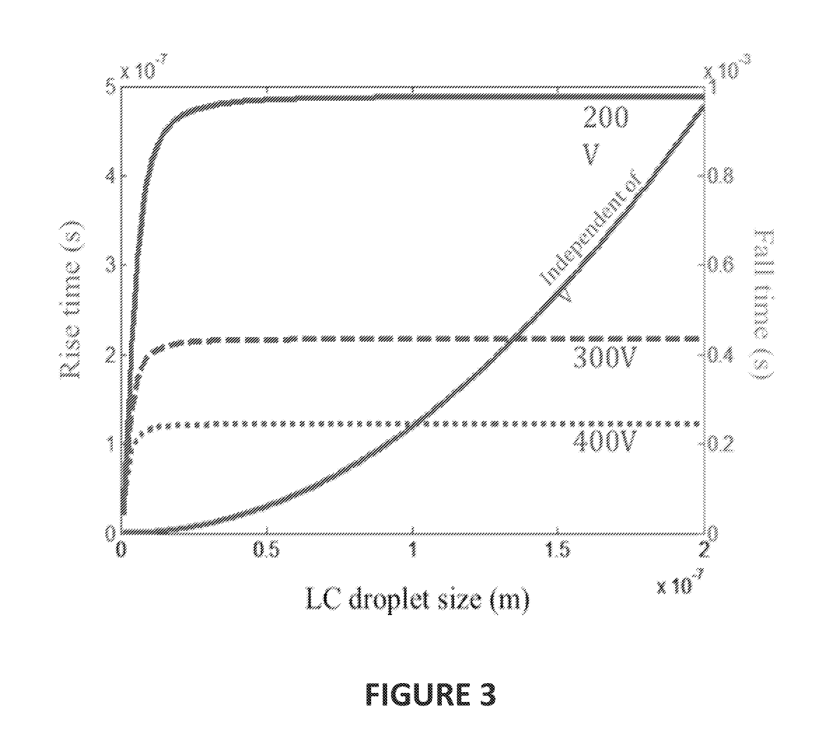

FIG. 3 is a graph of example estimated rise and fall times of a HPDLC at different applied voltages and for various droplet sizes. To reduce the size of the LC droplet to reach nanosecond switching time, the rate of polymerization of HPDLC may be increased, thus reducing the amount of polymerization time. Short phase separation time may lead to smaller droplets. Short phase separation time may lead to reduced scattering. In an example embodiment, a thiolene-based material set may be used. Various example additives may be included for rapid polymerization during exposure. Depending upon the amount of phase separation and droplet coalescence, the reflection efficiency and the switching speed may be experimentally determined From FIG. 3 it is evident that a diameter of an LC droplet size of about 25 nanometers (nm) may yield around 100 ns on time and 15 μs off time at 400 V. In addition, doping of the liquid crystal with a compatible high dielectric anisotropy compound may further enhance the switching speed and also help lowering the switching voltages.

In an example embodiment, a HPDLC may be doped with medium oxidized multiwalled carbon nanotubes (MWNT). The MWNT dopants may have two primary effects on the HPDLC: a reduction in liquid crystal droplet size and a change in the dielectric properties of the medium.

The MWNT doped HPDLCs may be formed from a thiolene based homogeneous blend of materials. For example, a blend of Norland Optical Adhesive 65, liquid crystal BL038, and a photoinitiator to sensitize the optical adhesive to visible wavelengths may be used. The MWNT may be added to the liquid crystal and thoroughly dispersed before the other ingredients are added to the blend. The MWNT used may be, for example, between about 5 μm and about 10 μm in length and may have an outer diameter of about 20 nm. The choice of size of MWNT may ensure that the diffusion constant of the MWNT is below that of the polymer and LC components. The conductivity of the MWNT may be about 10³ siemens per centimeter (S/cm), for example. The blend may then be sandwiched between two ITO coated glass slides spaced about 20 μm apart, for example.

The blend may then be exposed to an interference pattern generated by two laser beams. This interference pattern may be recorded in the sample to form a Bragg grating. The sample may then be cured under a UV lamp for about five minutes, for example, to polymerize any remnant monomers. The reflection efficiency as well as the capacitance and resistivity of the cells may vary depending on the concentration of MWNT used. High amounts of randomly aligned MWNTs may increase the probability of forming an electrical short between the ITO coated electrodes. A continuous drop in resistivity of the cells may be observed with increasing amounts of MWNTs. A change in the capacitance and resistivity may be indicative of a change in the dielectric properties of the HPDLC medium and hence for a given applied voltage a stronger electric field may be experienced by the LC droplets in the HPDLC cell.

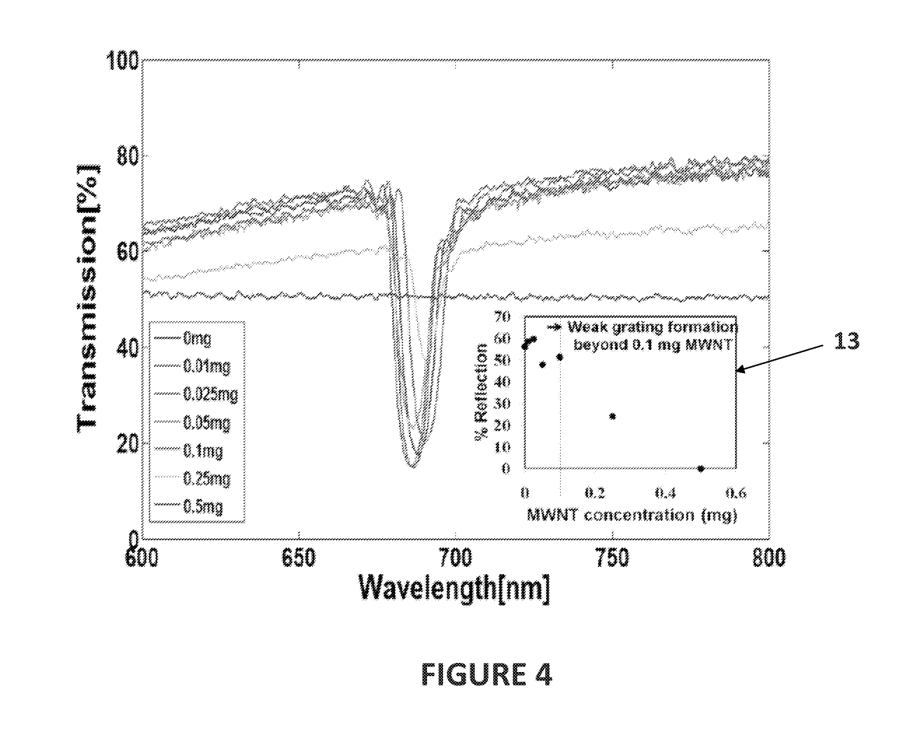

FIG. 4 illustrates an example transmission spectra of HPDLC reflection gratings with various concentrations of MWNT. The inset plot 13 illustrates a decrease in reflection efficiency with increasing MWNT amount.

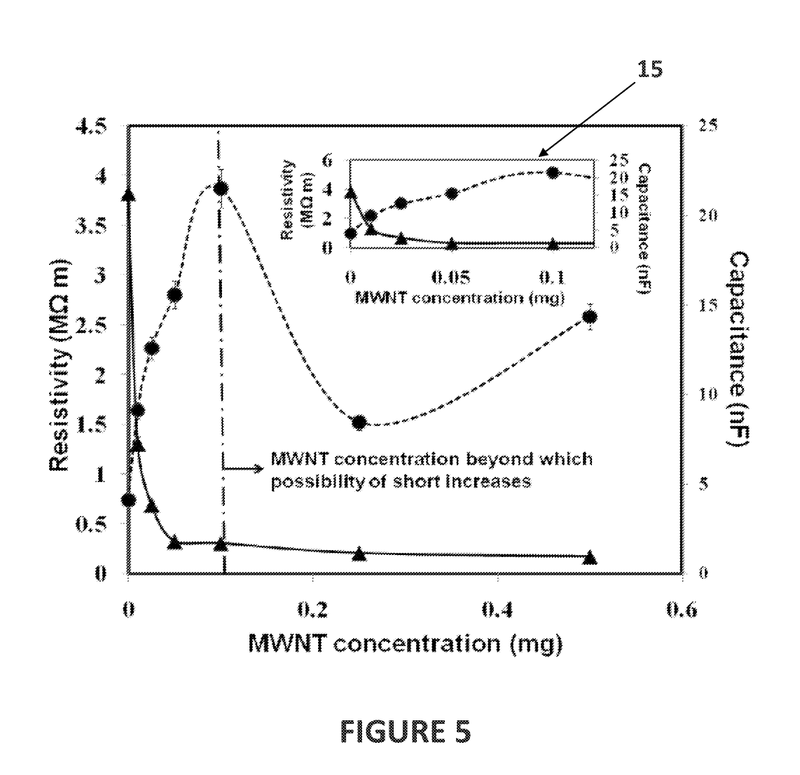

FIG. 5 illustrates plots depicting example changes in capacitance and resistivity of the HPDLC reflection gratings with MWNT at a driving frequency of 1 kHz. The inset plot 15 shows the range of MWNT concentration in which no shorting of the ITO electrodes is observed. The circles represent capacitance and the triangles represent resistivity.

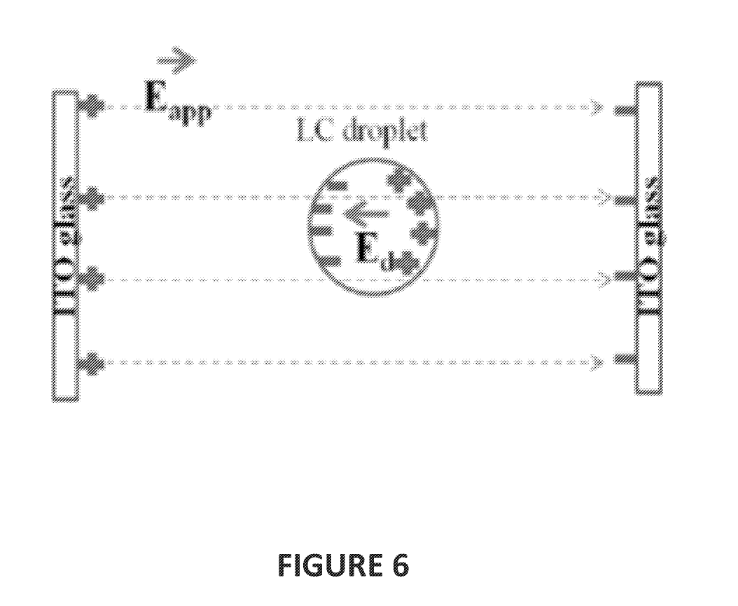

FIG. 6 is a schematic depicting an example applied electric field across an isolated LC droplet in a polymer matrix. E_{d} is the depolarizing field generated by the LC droplet.

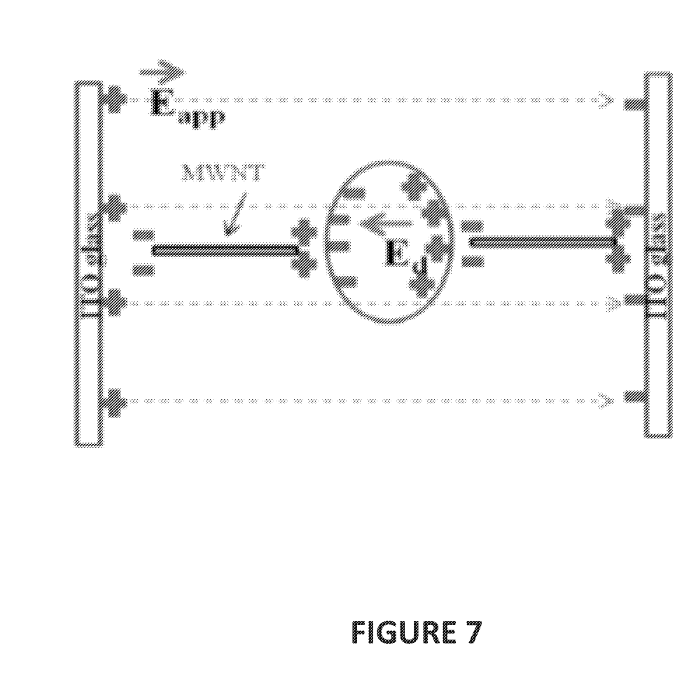

FIG. 7 is a schematic depicting an example applied electric field across an isolated LC droplet in a polymer matrix in the presence of MWNT enhancing the local electric field across the LC droplet. E_{d} is the depolarizing field generated by the LC droplet. As depicted in this scenario, the MWNT is aligned on either side of the LC droplet. In the presence of a MWNT in the vicinity of the LC droplet, the local electric field across the LC droplet may be enhanced, virtually bringing the electrodes close to the LC droplet as shown in FIG. 7. This local enhancement of the electric field across the droplet may cause a reduction in switching voltage. The concentration of MWNT may be below the percolation level such that shorting between the glass electrodes does not occur.

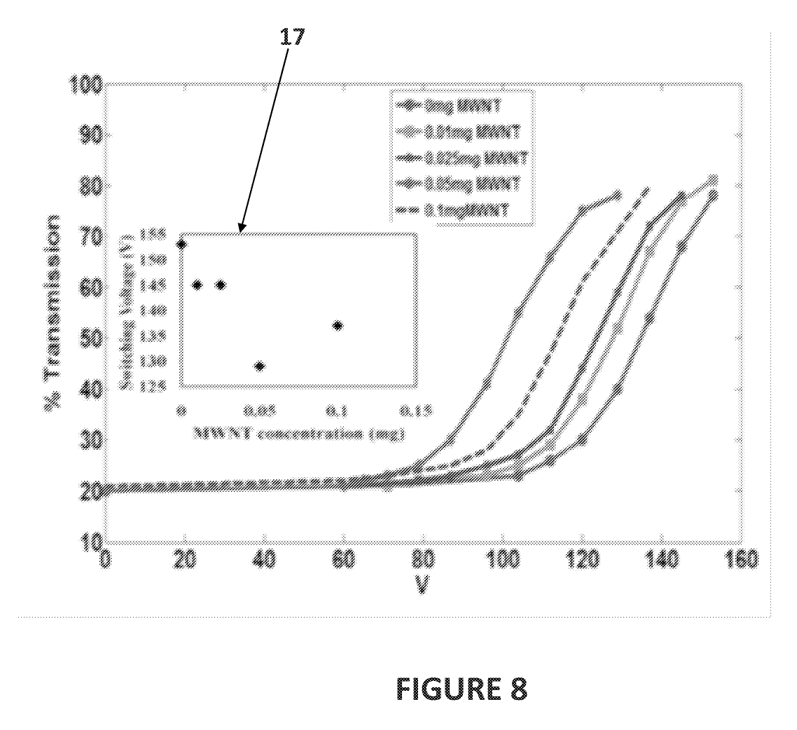

FIG. 8 illustrates example transmission as a function of applied voltage plots for various concentrations of MWNT. The inset plot 17 shows a reduction in switching voltage with increasing amount of MWNT.

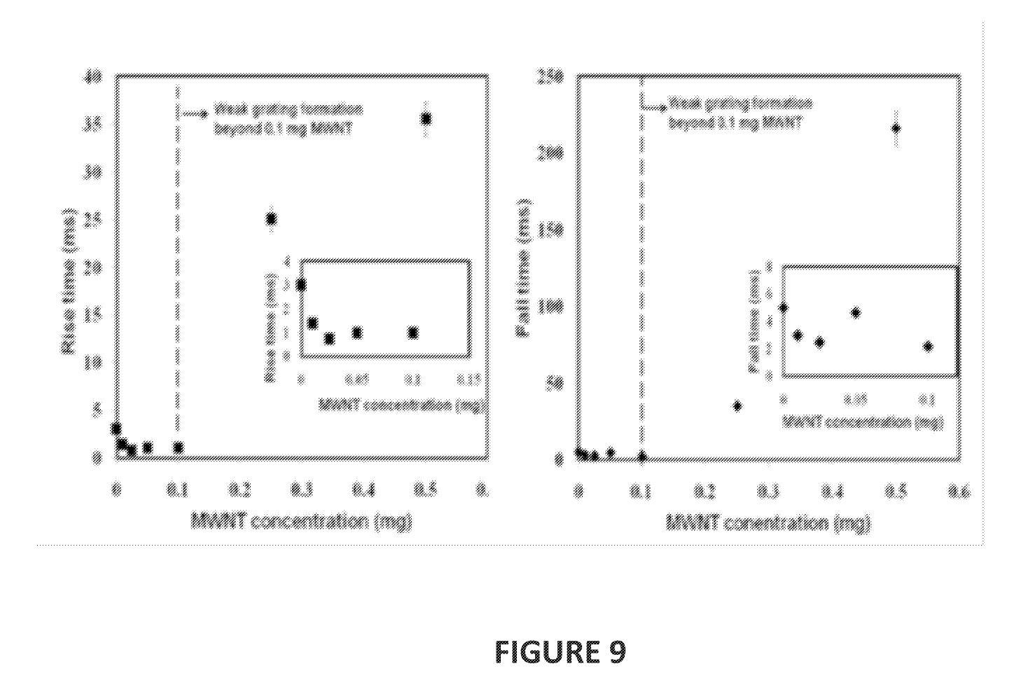

FIG. 9 illustrates example rise and fall time measurements of HPDLC reflection gratings with various concentrations of MWNT. The inset plots show the rise and fall time readings up to 0.1 mg MWNT. A reduction in switching time is also observed, as shown in FIG. 9. In HPDLC systems the rise time may be dependent upon the applied electric field and LC droplet size. All samples were switched at 137 V. The fall time is dependent on the droplet size and the viscoelastic coefficient of the LC. A reduction of both rise and fall time is indicative of the formation of smaller LC droplets. A decrease in both these parameters occurs up to a doping level of 0.1 mg but beyond this the rise and fall time dramatically increases at concentrations of 0.25 mg and 0.5 mg. The error bars in FIG. 9 indicate 5% error in each data point.

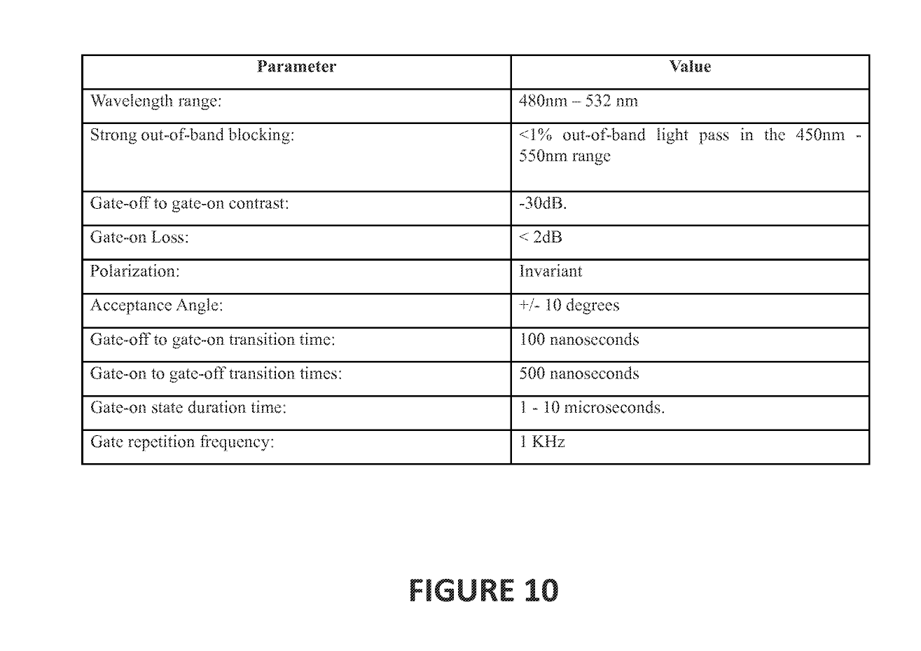

FIG. 10 is a chart depicting various example characteristics of a Holographic Optical Element (HOE) comprising a high switching speed HPDLC as described herein. In various example embodiments, a large-area switchable Holographic Optical Element (HOE) may be formed from stacked HPDLC gratings. A specific focus may be built into each grating layer. By overlaying several of these films with different focal points, a single collection mirror may be constructed that can electrically switch between focal points, thereby enabling beam collection to be steered between multiple instruments without incorporating moving parts. In addition, a ‘chopper’ function may be employed to allow multiple simultaneous measurements. An application for such a HOE may include light detection and ranging (LIDAR).

A technique for generating the herein described HPDLC mediums may involve dynamic variation of the holography setup during HPDLC formation, enabling the broadening of the HPDLC medium's wavelength response. Dynamic variation of the holography setup may include the rotation and/or translation of one or more motorized stages, allowing for time and spatial, or angular, multiplexing through variation of the incident angles of one or more laser beams on a pre-polymer mixture during manufacture. An HPDLC medium manufactured using these techniques may exhibit improved optical response by reflecting a hyperspectral broadband spectrum of wavelengths. Further, a broadband holographic polymer dispersed liquid crystal thin film polymeric mirror stack with electrically switchable beam steering capability may be generated. Additionally, a broadband holographic polymer dispersed liquid crystal thin film polymeric filter stack with electrically switchable beam steering capability may be generated.

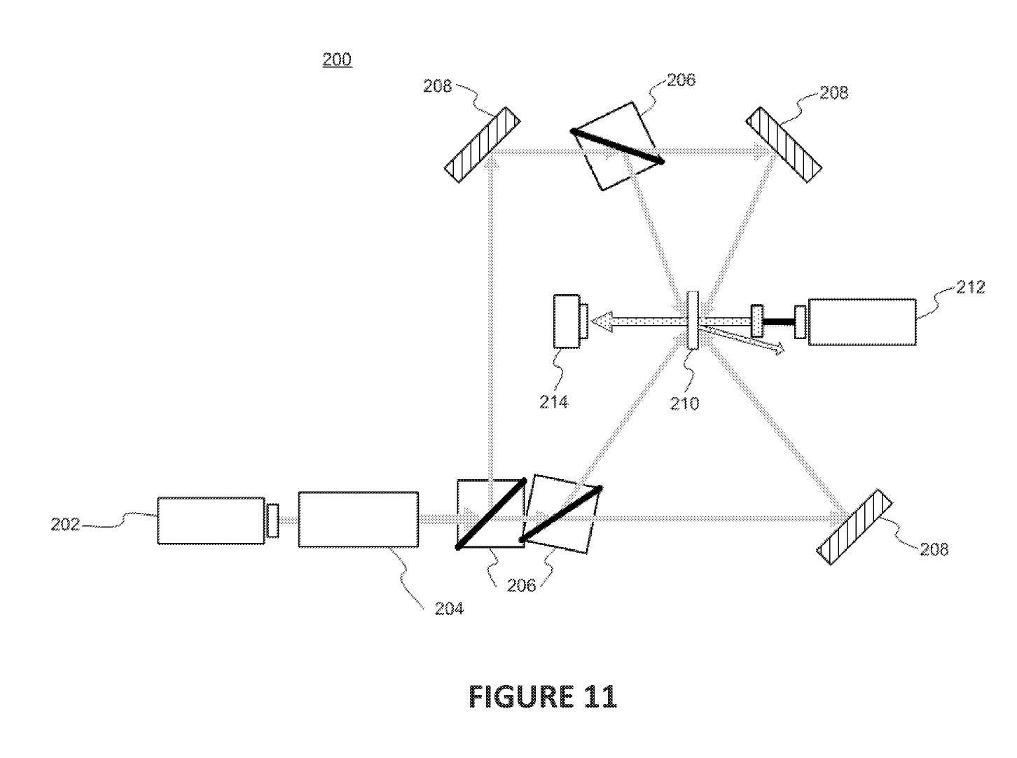

FIG. 11 depicts an example holography apparatus 200 used in the formation of hyperspectral broadband HPDLC mediums having fast switching speeds as disclosed herein. It should be noted that the apparatus depicted in FIG. 11 is an example embodiment, and that the number and positioning of individual elements of the apparatus may be varied without changing the scope of the claimed subject matter disclosed herein.

In the example apparatus depicted in FIG. 11, a fixed laser light source 202 may be focused on a beam expander 204. A laser light source used in the example embodiments was a Verdi Nd:YAG 5W green laser operating at 532 nm, but laser light sources emitting other wavelengths may be used. The beam expander may also comprise a spatial filter.

After laser light emitted from the laser light source passes through the beam expander and optional spatial filter, the beam may pass through one of more beam splitter plates 206, which may divide a single beam into two beams, and may also redirect the beams in separate directions. The beam splitters may be mounted on fixed stages (not shown), or alternatively may be mounted on motorized translation and/or rotation stages (not shown) that allow the beam splitter to be dynamically rotated and positioned in order to vary how an incident beam is split and/or its intensity varied. A motorized stage may be configured to rotate and/or translate an element mounted thereto in any of an x, y, or z axis. The use of variable beam splitter plates allows the relative intensity of individual beam pairs to be controlled. For example, variable beam splitter plates may be used to divert extra power into a specific beam pair, which in turn may result in more rapid phase separation thereby producing a reflection grating with higher reflection intensity. Conversely, the other beam pair may have a reduced power resulting in slower phase separation thereby producing a reflection grating with lower reflection efficiency. This method may permit wavelength mixing in a single film with controlled relative intensity of the individual gratings. In another example embodiment, laser output power may be controlled to enable the formation of notch and bandpass filters in an HPDLC medium.

In another example embodiment, using a series of beam splitters may result in many (e.g., 10) simultaneous interference spacings spread evenly across a grating pitch range. This configuration may be advantageous in the event that the formation of multiple grating pitches in a single volume of pre-polymer mixture requires each individual interference fringe spacing to be persistent during the entire exposure.

Beams of laser light may also be directed through the use of mirrors 208. The mirrors may be mounted on fixed stages (not shown), or alternatively may be mounted on motorized translation and/or rotation stages (not shown) that allow a mirror's surface to be dynamically rotated and positioned in order to vary the angle at which the mirror reflects light. A motorized stage may be configured to rotate and/or translate an element mounted thereto in any of an x, y, or z axis. The beams of laser light may ultimately be focused, for example through the use of beam splitters, mirrors, or the like, on a pre-polymer mixture sample 210 mounted on a sample stage (not shown). The sample stage may be fixed or may be a motorized translation and/or rotation stage.

An optional fixed white light source 212, for example a white light interferometer, may be operated during formation and focused so that it passes through the prepolymer mixture as the HPDLC is formed. Light that passes through the HPDLC may be detected by detector 214. Use of a white light interferometer and an associated detector during HPDLC formation may allow, for example, for various methods of testing, analyzing, and characterizing the performance of HPDLC mediums, discussed in more detail below. The positioning of the white light source and the detector depicted in FIG. 11 is merely an example, and other configurations are possible and intended to be within the scope of this disclosure.

The above described holography apparatus may be utilized to form enhanced broadband HPDLC mediums with broader ranges of reflected wavelengths and faster switching speeds than can be achieved by typical methods of HPDLC formation. In an embodiment, these enhanced broadband HPDLC mediums may be formed by dynamically varying elements of the above-described holography apparatus during formation. Dynamically varying elements of a holography apparatus may include, for example, the rotation and/or translation of one or more motorized stages having mirrors, beam splitters, or a pre-polymer mixture sample affixed thereto; thus allowing for time and spatial multiplexing during formation, as described in more detail below.

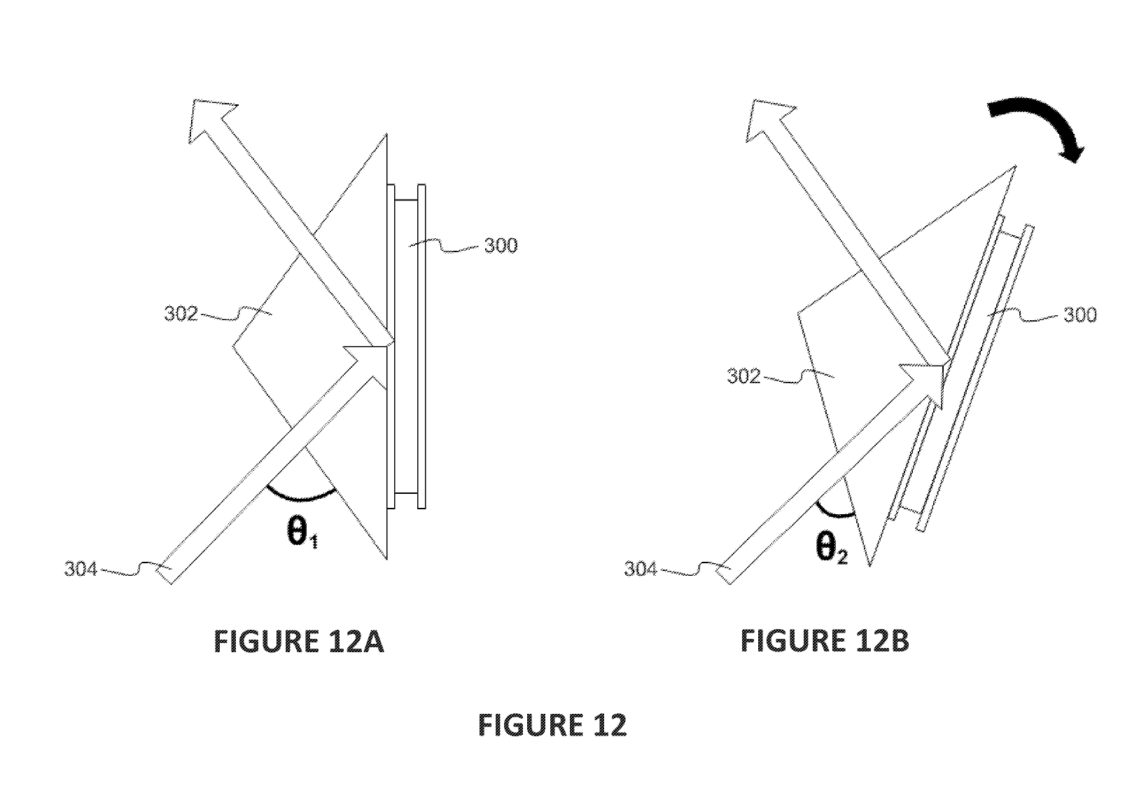

FIG. 12 comprising FIG. 12A and FIG. 12B depict an example technique for dynamically varying a holography apparatus during formation to broaden the interaction wavelength of an HPDLC medium via simultaneous time and spatial, or angular, multiplexing. The apparatus of FIG. 11 may be used, and modified as described herein. A pre-polymer sample 300 comprising a single layer of pre-polymer mixture may be mounted to a motorized translation and/or rotation capable sample stage. In an embodiment, a prism 302 may also be mounted to the sample stage so that the prism makes contact with the pre-polymer sample. A single beam of laser light may be directed to be incident on the prism/sample. As the incident laser beam passes through the prism as depicted in FIGS. 12A and 12B, and is reflected, diffracted, or otherwise affected, interference patterns may be created in the pre-polymer mixture that in turn result in the formation of reflection gratings in the resulting HPDLC medium. During laser beam exposure, the sample stage may rotate and/or translate along one or more of an x, y, or z axis. Rotation and/or translation of the sample stage allows the exposure angles of incident laser beam 304 during grating formation to be varied, for example via clockwise rotation of the sample stage from θ₁ in FIG. 12A to θ₂ in FIG. 12B along an axis perpendicular to the sample. A similar effect may be achieved with the use of a fixed or stationary sample stage, and through varying the angle of incidence of the laser beam itself, for example through the use of mirrors mounted to rotation and/or translation stages. The angle of incidence of the laser beam on the pre-polymer mixture may be varied continuously, or in incremental degrees by controlling the rotation and/or translation of holographic elements accordingly. Varying the angle of incidence of the laser beam on the pre-polymer mixture may cause interference patterns to form in the mixture, in turn resulting in the formation of multiple reflection gratings in the resulting HPDLC medium. These multiple gratings may have varying Bragg grating pitches and/or central wavelengths that overlap spatially and/or spectrally, thus forming an HPDLC medium with continuous broadband gratings capable of reflecting a broad range of wavelengths.

A variation of the single-beam holographic technique depicted in FIGS. 12A and 12B may be achieved by affixing a mirror (not shown) to the back of the pre-polymer mixture sample holder. The prism depicted in FIGS. 12A and 12B may be omitted as a result of adding the mirror to the sample holder. The mirror may induce self-interference in the incident laser beam, creating interference patterns in the pre-polymer mixture that in turn result in the formation of reflection gratings in the resulting HPDLC medium. During laser beam exposure, the sample stage may rotate and/or translate along one or more of an x, y, or z axis. Rotation and/or translation of the sample stage allows the exposure angles of incident laser beam 304 during grating formation to be varied, for example via clockwise rotation of the sample stage from θ₁ in FIG. 12A to θ₂ in FIG. 12B along an axis perpendicular to the sample. A similar effect may be achieved with the use of a fixed or stationary sample stage, and through varying the angle of incidence of the laser beam itself, for example through the use of mirrors mounted to rotation and/or translation stages. The angle of incidence of the laser beam on the pre-polymer mixture may be varied continuously, or in incremental degrees by controlling the rotation and/or translation of holographic elements accordingly. Varying the angle of incidence of the laser beam on the pre-polymer mixture may cause multiple interference patterns to form in the mixture, in turn resulting in the formation of multiple reflection gratings in the resulting HPDLC medium. These multiple gratings may have varying Bragg grating pitches and/or central wavelengths that overlap spatially and/or spectrally, thus forming an HPDLC medium with continuous broadband gratings capable of reflecting a broad range of wavelengths.

In yet another example embodiment of HPDLC formation using angular multiplexing, the holographic exposure apparatus may be configured with multiple pairs of counter-propagating beams, as depicted in FIG. 11. Although two beam pairs (i.e., four beams) are depicted, the scope of the disclosure should not be limited thereto, and additional beam pairs may be added. Additional sources of laser light, of the same or different wavelengths, may also be used in the generation of laser beam pairs. Exposing a sample of pre-polymer mixture using the angular multiplexing technique described herein provides the ability to simultaneously write multiple gratings in a single HPDLC medium. An HPDLC medium having a broadband reflection peak or multiple reflection peaks may result. In order to write two reflection gratings simultaneously, the laser output power may be set to 2 W, and the beam may be expanded and masked to a 1-inch diameter circle. Using beam splitter plates, two beam pairs (i.e., four beams) may be created and aligned so that each beam pair writes a different pitch grating in the HPDLC medium. For example, splitting the 2 W, expanded and masked beam into two beam pairs may result in four beams, with the resultant power in each beam being approximately 100 mW/cm². As previously mentioned, the use of variable beam splitter plates may allow the relative intensity of the beam pairs to be controlled, thereby allowing for tuning of the reflection intensity of individual reflection gratings formed within the HPDLC medium.

Referring again to FIG. 11, angular multiplexing of the four-beam embodiment may involve rotation and/or translation of the sample stage along one or more axes. In an example embodiment, a sample stage holding the pre-polymer mixture may be so rotated and/or translated in order to alter the angle of incidence of one or more of the laser beams on the surface of the pre-polymer mixture. The rotation and/or translation motion may be continuous, incremental with respect to time, or any combination thereof. Altering the angle of incidence of one or more of the counter-propagating laser beams on the surface of the pre-polymer mixture allows for the creation of multiple interference patterns and in turn multiple reflection gratings in the resulting HPDLC medium. The intensity of one of more of the incident laser beams may be varied, for example by the use of variable beam splitter plates 206, in order to create reflection gratings of varying intensity.

In another example, one or more motorized stages may be employed for rotation and/or translation of other elements of the apparatus, for example beam splitters 206, or mirrors 208. The use of additional motorized stages may be used concurrently with or in lieu of rotation and/or translation of the sample stage. The angle of incidence of one or more of the laser beams on the pre-polymer mixture may be altered via such rotation and/or translation, while one or more remaining laser beams may be held at a fixed angle of incidence. Rotation and/or translation of motorized stages having beam splitters or mirrors mounted thereto may allow for individual or simultaneous focusing of the laser beams, thereby allowing for a high degree of tunability in the creation of interference patterns within the pre-polymer mixture. Simultaneous rotation and or translation of both the sample stage and one or more additional motorized stages with beam splitters or mirrors mounted thereto provides the ability to ensure that individual beams are not reflected, diffracted, or otherwise mitigated by any portion of the physical mounting apparatus of the mounting stage.

The above-disclosed angular multiplexing techniques may result in multiplexed broadband Bragg gratings comprising peak reflection wavelengths of approximately 100 nm full width at half maximum (FWHM) or greater. Apparatus configuration parameters that may affect formation include variation speed of the angle of incidence, uniformity of the reflection wavelength, uniformity of the reflection intensity, incident power, and the like.

In order to effectuate transfer of an HPDLC medium by releasing a glass substrate from an HPDLC sample, thereby facilitating grating surface metrology, the surfaces of the glass substrates are treated prior to holographic exposure with a release agent (e.g., surfactants such as Tween and Brix). Treatment with a release agent facilitates complete removal of an HPDLC medium. Following holographic exposure, one glass substrate may be released from the HPDLC medium and HPDLC medium removed. The grating film may then be adhered to an index-matched polymeric substrate coated with an index-matched conducting substrate using the same polymer employed in the grating matrix of the HPDLC medium (e.g., acrylated urethane). An example substrate suited for this purpose is poly-methyl-meth-acrylate (PMMA) coated with Baytron-P conducting polymer, but other substrates may be used. The remaining glass substrate may then be similarly replaced with a second polymeric substrate. If this process is repeated, an index matched completely polymeric HPDLC medium stack may be formed. In an example process, hardening polymers (e.g., Norland Optical Adhesive 63 and/or 68) may be added to the pre-polymer mixture, to increase the toughness of the resulting HPDLC medium.

HPDLC mediums formed using the methods and apparatus disclosed herein often demonstrate reflection efficiencies of 85-90%, switching fields of approximately 15-20 V/μm, and switching times less than 2 ms. Scattering intensities are typically less than 1×10⁻⁷ dB outside the grating reflection peak. Wavelength shifts are typically less than 0.005, which may be measured using, for example, a Zygo white light interferometer.

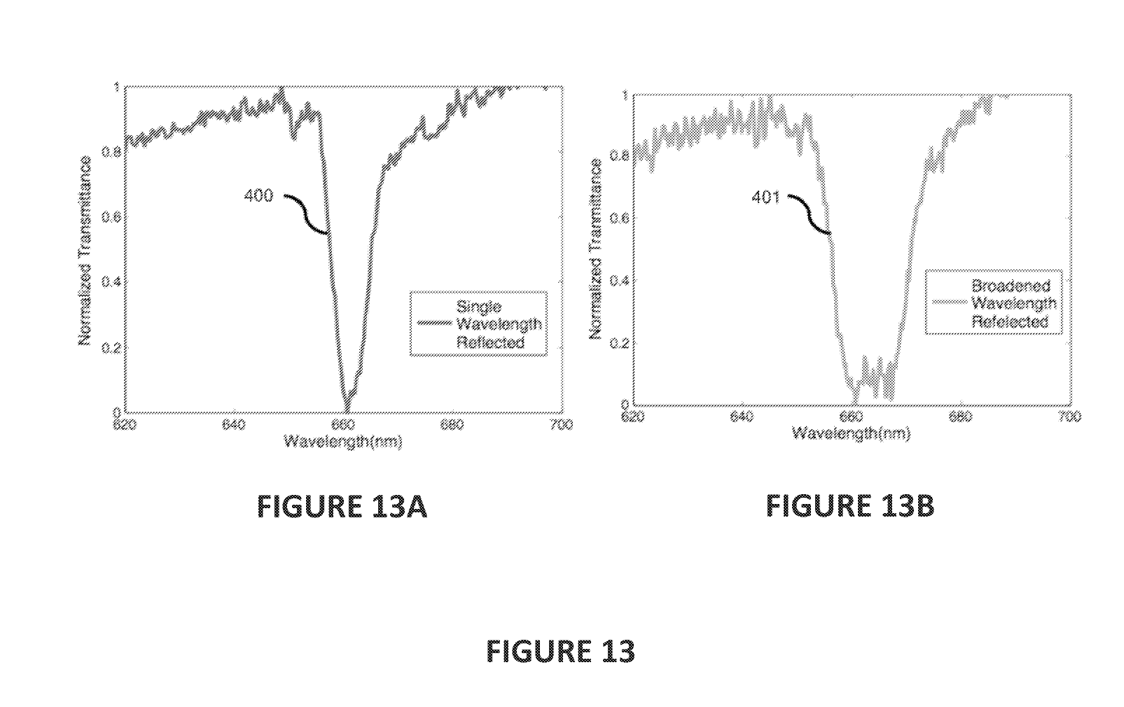

FIG. 13, which includes FIG. 13A and FIG. 13B, illustrates an example of broadened peak reflective characteristics achievable in an HPDLC medium through the creation of multiple reflections gratings using the techniques disclosed herein, in comparison to peak reflective characteristics of a typical single grating HPDLC medium. The reflective behavior of the example single grating HPDLC medium depicted in FIG. 13A has a normalized peak reflection wavelength with a full width at half maximum (FWHM) of 9 nm at 662.2 nm, depicted by the plotted line 400. FIG. 13B depicts an example hyperspectral HPDLC medium containing an infinite number of multiple reflection gratings created using the techniques disclosed herein. In comparison with the single grating HPDLC medium depicted in FIG. 13A, the multiple reflection grating HPDLC medium depicted in FIG. 13B exhibits a broadened peak reflection wavelength of 15 nm, depicted by the plotted line 401.

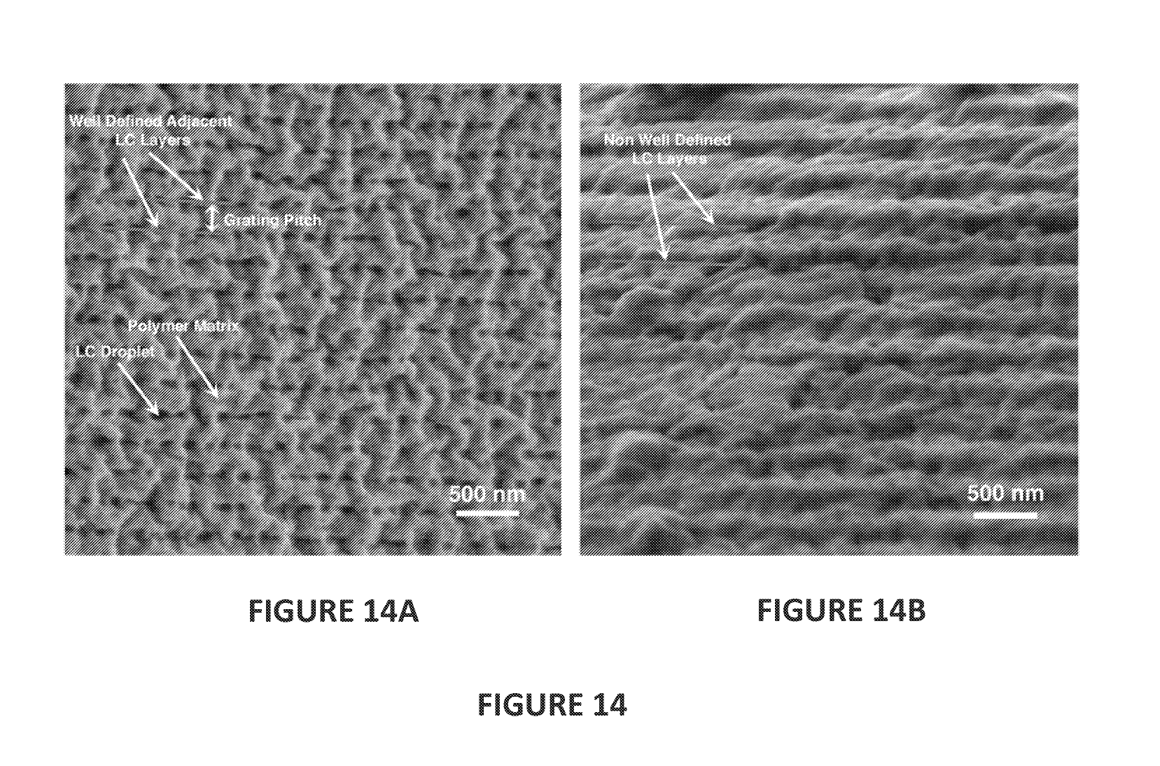

Nanoscale internal morphology of broadband HPDLC gratings may be studied using microscopy techniques, for example a scanning electron microscopy (SEM) technique can be used. FIG. 14, which includes FIG. 14A and FIG. 14B, depicts SEM micrograph images of a single wavelength reflecting and broadband wavelength reflecting HPDLC mediums respectively. In FIG. 14A the dark voids are liquid crystal (LC) droplets surrounded by a polymer matrix. The dark LC voids are arranged in parallel layers forming a periodic Bragg grating structure. The distance between the LC layers is termed as the grating pitch. The grating pitch is typically uniform for single wavelength reflecting HPDLC mediums. FIG. 14B represents a broadband wavelength reflecting HPDLC medium. Due to dynamic movement of a holography apparatus during fabrication, multiple gratings may be formed resulting in an overlapping LC layer structure. This structure results in a nonuniform grating pitch and a broadening of the wavelength reflected by the HPDLC medium of FIG. 14B.

Various grating characteristics of HPDLC mediums may be analyzed to optimize performance. For example, the uniformity of the wavelength reflection peak can be determined. The exposed HPDLC medium may be analyzed using a spectra-radiometer to measure reflection properties of the gratings in multiple locations to ensure uniformity in the exposure process. Other parameters to be examined within each measurement may include wavelength peak, reflection intensity, spatial uniformity, and the like. In another example, the wavefront may be analyzed. Maintaining the wavefront properties of individual wave packets as they interact with the reflecting film ensures accurate measurement at the detector. In yet another example, HPDLC mediums may be examined using a white light interferometer, for example, to measure scatter. Scattering of reflected and transmitted light may result in stray measurements and noise at the detector. This scattering effect may be characterized and compared to scatter effects from existing reflective technologies in order to mitigate or minimize the effect. In yet another example, electro-optic switching properties of an HPDLC medium can be analyzed. This may be accomplished with the use of a spectra-radiometer and high-voltage (e.g., ˜100V pp) switching setup, for example. When a high-frequency (e.g., 1 kHz) oscillating wave is applied to an HPDLC medium, the liquid crystal droplets align, effectively ‘washing out’ the Bragg grating. This enables partial switching of the entire grating, which can be used to ‘grayscale’ or vary the intensity of the grating. An HPDLC medium may be analyzed for uniformity in color purity, intensity, focal length and direction, and polarization during dynamic switching and grayscale switching.

The optical output behavior of reflective HPDLCs may be modeled using methods such as coupled wave theory and matrix approaches. To enable such modeling each layer of polymer and liquid crystal may be considered individually stacked, forming a periodic grating profile. In the coupled wave theory approach, the dielectric medium is typically isotropic and the refractive index varies in a sinusoidal fashion. The reflected beam may be coupled to the incident beam, giving an expression for the energy transfer efficiency. Different matrix approaches also can be used to deduce the output of the HPDLCs by considering Maxwell's equations in a matrix form. A 2×2 matrix approach has 2 element field vectors. The liquid crystal (LC) layer may be assumed to be isotropic. In a 4×4 matrix approach, there are 4 field vectors corresponding to electric and magnetic fields for 2 independent polarization modes. This may be useful for describing birefringent LCs. The characteristic matrix for LC and polymer layers, beginning from one end of the stack, may be computed and then the field vectors may be propagated to the other end of the stack by taking the product of the individual layer transfer matrices. A particular HPDLC reflecting wavelength can be tailor-made by theoretically modeling them individually.

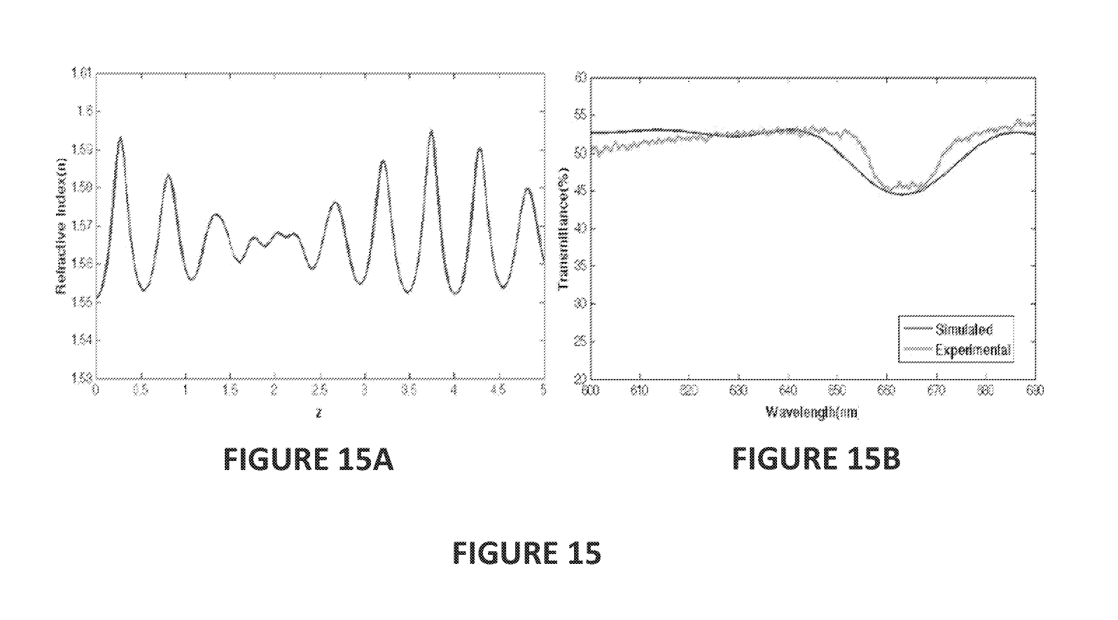

For example, FIG. 15, which includes FIG. 15A and FIG. 15B, depicts an example of theoretical modeling of a broadband HPDLC medium using Berreman's 4×4 matrix technique. Generally, the refractive index of a broadband grating is not uniform due to overlapping reflective gratings. This phenomena can be modeled by using a phenomenological diffusion model. FIG. 15A shows a modeled nonuniform refractive index profile of an example broadband grating. Here, the unit z depicts the thickness of the grating in microns. By substituting the refractive index profile using Berreman's 4×4 matrix technique, the output of the broadband grating can be accurately predicted and/or modeled as depicted in FIG. 15B. Thus, one may first theoretically design a desired HPDLC reflecting wavelength spectrum using the Berreman 4×4 technique and the phenomenological diffusion model. The parameters resulting from the theoretical prediction may be used to fabricate the HPDLC medium corresponding to the desired spectrum. In an example configuration, modeling may be used utilized to predict the output of a broadband HPDLC medium.

In an embodiment, broadband HPDLC mediums formed using the methods and apparatus disclosed herein may be utilized to form lightweight mirrors with electronically switchable focal points for remote sensing. Broadband HPDLC mediums formed using the methods and apparatus disclosed herein may be utilized to form lightweight filters with electronically switchable focal points for remote sensing. Broadband HPDLC mediums may be stacked in one configuration of such a mirror. And broadband HPDLC mediums may be stacked in one configuration of such a filter. Electrically switchable thin-film polymeric stacks (mirror, filter) exhibit good optical characteristics and typically only weigh several pounds, even when including drive electronics. In an example configuration, each layer of the stack comprises a spherically curved Bragg grating with a focal point independent from the other layers. This configuration enables such applications as electrically refocused virtual mirrors for instrument clustering.

Broadband HPDLC stacks as disclosed herein may be constructed by forming, for example, 5 cm diameter broadband HPDLC reflecting mirrors, and laminating them together. One laminating technique that may be used in the construction of a stack comprises gluing the HPDLC mirror films together using optical adhesive. To adhere multiple HPDLC mirror films together using optical adhesive, the HPDLC mirror films may be formed on traditional ITO-coated glass substrates, and may be laminated into a stack using optical adhesive. An example of a suitable adhesive is Norland Optical Adhesive 71, as it possesses several advantageous characteristics, for example UV optical curing that permits precise alignment with no time pressure, very low absorption in the visible wavelength regime resulting in low optical transmission loss, and index of refraction matching the glass substrates, but other adhesives may be used.

Another technique for laminating HPDLC mirror films together to form a mirror stack may involve transferring the HPDLC mirror films (after holographic exposure) to index matched polymeric substrates coated with conducting layers, thereby reducing optical losses through the stack. The HPDLC stack laminating techniques disclosed herein are merely examples. Alternative laminating techniques may be obvious to those skilled in the art, and are meant to be included within the scope of this disclosure.

A broadband HPDLC medium with one or more spherically curved Bragg gratings may be formed using the above-disclosed apparatus and techniques, wherein the exposure technique incorporates a spherical wave to form spherical focusing reflection gratings. To create spherical interference patterns in a pre-polymer mixture, spherical beam expanding methods may be used to holographically expose the pre-polymer mixture. Spherical beam expanding methods may also be used to examine the optical qualities of the resulting spherical gratings. Exposure methods may be adjusted to compensate characteristics of the pre-polymer mixture. For example, the aforementioned holographic techniques work by creating volume interference patterns, which are recorded regardless of the media, and may need to be altered to form high-quality gratings due to the volume of the pre-polymer mixture. Spherically expanded laser beams may be used to form a spherically curved Bragg reflection grating. Exposure condition factors that may be considered during formation include beam power, beam expansion quality, beam coherence, and time of exposure.

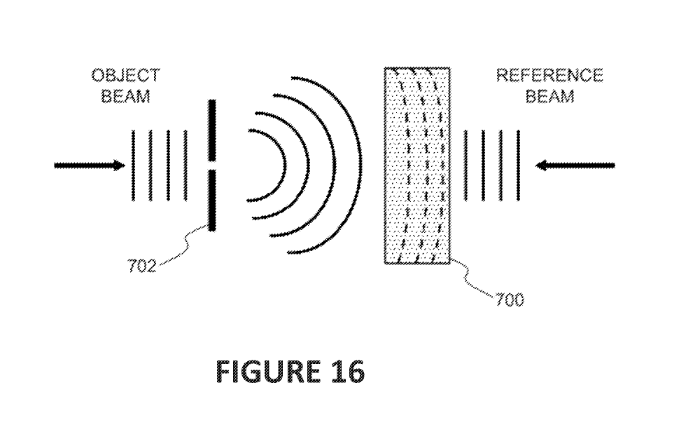

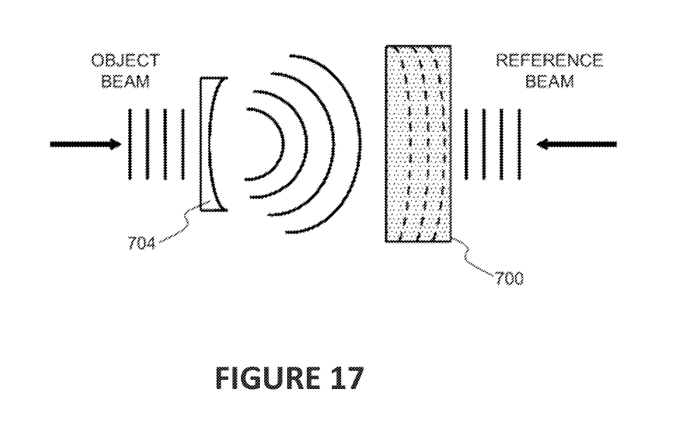

FIG. 16 and FIG. 17 depict two example methods of creating spherically expanded laser beams. The first method, depicted in FIG. 16 involves placing a plate having a pinhole 702 between the object beam from a laser light source and the pre-polymer mixture 700. Passing through the pinhole causes spherical expansion of the object beam wavefront. The spherically expanded object beam interferes in the pre-polymer mixture with the plane wavefronts of a reference beam, forming an interference pattern in the pre-polymer mixture and resulting in a focusing, curved grating pattern of high index (liquid crystal) and low index (polymer) layers.

The second method, depicted in FIG. 17 involves placing a plano-concave lens 704 between the object beam from a laser light source and the pre-polymer mixture 700. Passing through the plano-concave lens causes spherical expansion of the object beam wavefront. The spherically expanded object beam interferes in the pre-polymer mixture with the plane wavefronts of a reference beam, forming an interference pattern in the pre-polymer mixture and resulting in a focusing, curved grating pattern of high index (liquid crystal) and low index (polymer) layers.

An example application of electrically-switchable thin-film polymeric mirrors lies in the optics systems of satellites. A significant limiting factor for satellite design is overall weight, particularly the relatively heavy optics associated with the primary mirrors typically used in satellites for collecting and focusing light on instrumentation, for example cameras, spectrometers, and the like. Additional design considerations include potential complications and weight associated with mechanically-operated beam steering optics typically necessary to utilize multiple instruments with a single primary collection mirror. Current state-of-the-art satellite optics technology employs polished aluminum mirrors, weighing up to several hundred pounds for a one-meter diameter mirror. Cost per pound of payload launched into low earth orbit typically places severe restrictions on the size and extent of light collection devices that can be included on specific missions. The herein described electrically-switchable thin-film polymeric mirrors may allow clustering of multiple scientific instruments around a single lightweight primary mirror and redirection of the focal point of the mirror to individual instruments, using devices that do not require moving parts.

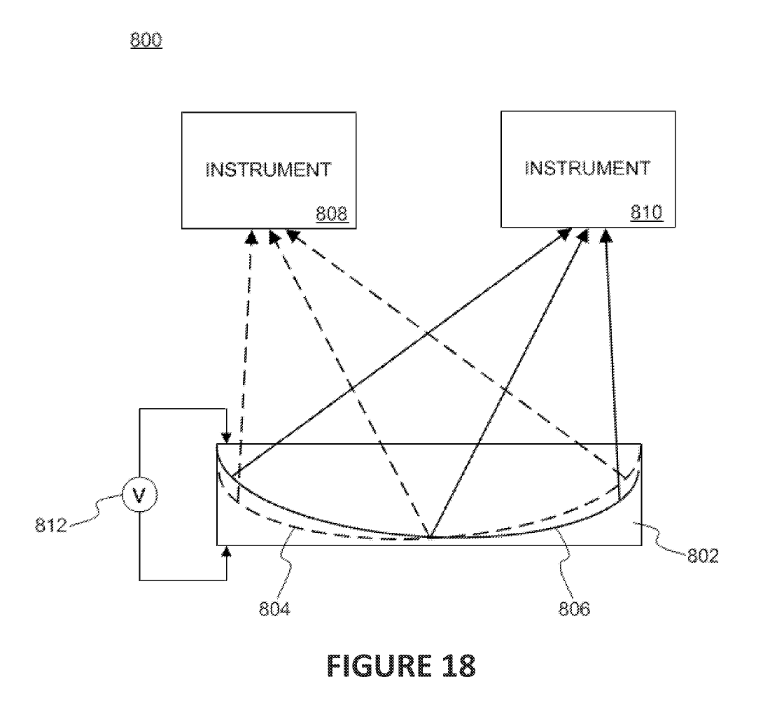

FIG. 18 depicts an example apparatus 800 comprising an electrically-switched thin-film polymeric stack 802. The stack may be constructed from broadband HPDLC thin films as formed as disclosed herein. Two spherically curved Bragg gratings 804 and 806 are focused on instruments 808 and 810 respectively. Instruments 808 and 810 may be any instrumentation for which switchable mirror optics is desirable, for example cameras, spectrometers, and the like. The stack may be electrically-switchable, for example by application of a voltage 812. In an embodiment, varying the voltage applied to the HPDLC may cause grating 804 to be transparent, while grating 806 reflects a broadband peak wavelength to instrument 810. A different variation of applied voltage may cause grating 806 to become transparent while grating 804 reflects a broadband peak wavelength to instrument 808. Thus, by simply varying the applied voltage, different mirrors in the HPDLC stack may be quickly and efficiently turned “on” and “off,” effectively changing the stack's focus between different instruments. In this manner, an electrically-switched thin-film polymeric stack (e.g., mirror, filter)r may serve to replace typical mechanically-operated beam steering optics. It may also be possible using the techniques disclosed herein to direct reflected light properties including wavefront, scatter, and polarization. The electrically-switchable mirrors and/or filters disclosed herein may also be useful a number of other applications, for example LIDAR, radar mapping, oceanographic measurements, and spectral analysis.

The electrically-switchable mirrors and/or filters disclosed herein may also incorporate wavelength filtering capabilities. For example, when electrically-switchable mirrors comprise a multi-color stack, individual HPDLC mediums can be electrically tuned to reject any given visible wavelength through color addition algorithms. A simple example configuration comprises a three-color red-green-blue stack, however, many different color HPDLC mediums can be stacked allowing for finer control over the wavelengths reflected. Wavelength filtering using HPDLC stacks is particularly suited to charge-coupled device (CCD) color filtration, for example in remote sensing and hyperspectral work, where it is desirable to avoid the use of moving parts.

Various characteristics of spherically curved gratings may be analyzed to optimize performance. For example, the uniformity of the wavelength reflection peak can be determined. The exposed HPDLC medium may be analyzed using a spectra-radiometer to measure reflection properties of the curved gratings in multiple locations to ensure uniformity in the exposure process. Parameters to be examined within each measurement may include wavelength peak, reflection intensity, spatial uniformity, and the like. In another example, the wavefront may be analyzed. Maintaining the wavefront properties of individual wave packets as they interact with the reflecting film ensures accurate measurement at the detector. In yet another example, HPDLC mediums may be examined using a white light interferometer, for example, to measure scatter. Scattering of reflected and transmitted light may result in stray measurements and noise at the detector. This scattering effect may be characterized and compared to scattering effects of existing mirror technologies in order to mitigate or minimize this effect. In yet another example, Electro-optic switching properties of spherically curved gratings can be analyzed. This may be accomplished with the use of a spectra-radiometer and high-voltage (e.g., ˜100V p-p) switching setup, for example. When a high-frequency (e.g., 1 kHz) oscillating wave is applied to the spherically curved gratings, the liquid crystal droplets align, effectively ‘washing out’ the Bragg grating. This enables partial switching of the entire grating, which can be used to ‘grayscale’ or vary the intensity of the grating. Spherically curved gratings may be analyzed for uniformity in color purity, intensity, focal length and direction, and polarization during dynamic switching and grayscale switching.

In order to effectuate transfer of an HPDLC medium by releasing a glass substrate from an HPDLC sample, thereby facilitating grating surface metrology, the surfaces of the glass substrates may be treated prior to holographic exposure with a release agent (e.g., surfactants such as Tween and Brix). Treatment with a release agent facilitates complete removal of an HPDLC medium. Following holographic exposure, one glass substrate may be released from the HPDLC medium and HPDLC medium removed. The grating film may then be adhered to an index-matched polymeric substrate coated with an index-matched conducting substrate using the same polymer employed in the grating matrix of the HPDLC medium (e.g., acrylated urethane). An example substrate suited for this purpose is poly-methyl-meth-acrylate (PMMA) coated with Baytron-P conducting polymer, but other substrates may be used. The remaining glass substrate may then be similarly replaced with a second polymeric substrate. If this process is repeated, an index matched completely polymeric HPDLC stack may be formed. In an example process, hardening polymers (e.g., Norland Optical Adhesive 63 and/or 68) may be added to the prepolymer mixture, to increase the toughness of the resulting HPDLC medium.

The dynamically formed broadband HPDLC mediums disclosed herein have useful applications in a wide array of optical devices, for example optical devices designed for beam steering for instrument clusters, hyperspectral imaging, wavelength filtering. Beam steering using stacked broadband HPDLC films with spherically curved gratings can provide the ability to selectively focus specific wavelengths among numerous instruments, for example in space-borne satellite applications. The high color purity exhibited by these HPDLC mediums is a desirable feature for hyperspectral imaging, where objects may be analyzed using different spectral sections. Use of broadband HPDLC mediums as light filters can allow for higher device sensitivity and reliability. Optical devices incorporating these broadband HPDLC mediums may: contain no moving parts; be light weight; and have small physical footprints compared to typical prisms and lenses, thus providing critical advantages when vibration, weight, and real estate are critical design parameters.

Broadband HPDLC mediums are well suited for use in full-color reflective displays, where their high color purity and balanced white point are desirable. Also, H-PDLC films have demonstrated sub-millisecond response times because of the large surface-to-volume ratio, making video rate switching, and perhaps time sequential switching, possible. Other useful applications for broadband HPDLC mediums in optical devices include electrically controllable lenses for use in remote sensing, filter arrays for display and wavelength filtering, optical color filters for micro-displays, application-specific integrated lenses to perform the function of individual lenses, mirrors, prisms, electro-optic switches for routing particular wavelengths, tunable photonic crystals, and controllable photomasks.

What is claimed is:

1. A hyperspectral holographic polymer dispersed liquid crystal medium comprising at least one dielectric dopant, wherein:
the hyperspectral holographic polymer dispersed liquid crystal medium reflects a hyperspectral continuum of optical energy within a spectrum:
the hyperspectral continuum of peak reflective wavelengths ranges from a first peak reflective wavelength indicative of a first end of the spectrum to a second peak reflective wavelength indicative of a second end of the spectrum; and
the hyperspectral continuum of peak reflective wavelengths is electrically controllable.

2. The hyperspectral holographic polymer dispersed liquid crystal medium of claim 1, wherein the dielectric dopant comprises a carbon nanoparticle.

3. The hyperspectral holographic polymer dispersed liquid crystal medium of claim 1, wherein the dielectric dopant comprises a piezoelectric nanoparticle.

4. The hyperspectral holographic polymer dispersed liquid crystal medium of claim 1, wherein the dielectric dopant comprises a semiconductor nanoparticle.

5. The hyperspectral holographic polymer dispersed liquid crystal medium of claim 1, wherein the dielectric dopant comprises an electrically conductive nanoparticle.

6. The hyperspectral holographic polymer dispersed liquid crystal medium of claim 1, wherein the dielectric dopant comprises a metallic nanoparticle.

7. The hyperspectral holographic polymer dispersed liquid crystal medium of claim 1, wherein a diameter of a droplet size of the liquid crystal is in a range of about 300 nanometers to 5 micrometers.

8. The hyperspectral holographic polymer dispersed liquid crystal medium of claim 1, wherein the dielectric dopant comprises an anisotropy compound.

9. The hyperspectral holographic polymer dispersed liquid crystal medium of claim 1, wherein the dielectric dopant comprises a high dielectric anisotropy compound.

10. The hyperspectral holographic polymer dispersed liquid crystal medium of claim 1, wherein the dielectric dopant comprises thiolene-based material.

11. The hyperspectral holographic polymer dispersed liquid crystal medium of claim 1, wherein the dielectric dopant comprises a multiwalled carbon nanotubes.

12. The hyperspectral holographic polymer dispersed liquid crystal medium of claim 11, wherein a multiwalled carbon nanotube of the multiwalled carbon nanotubes has an outer diameter of about 20 μm.

13. The hyperspectral holographic polymer dispersed liquid crystal medium of claim 11, wherein a multiwalled carbon nanotube of the multiwalled carbon nanotubes has a length between about 5 μm and about 10 μm.

14. The hyperspectral holographic polymer dispersed liquid crystal medium of claim 11, wherein a conductivity of a multiwalled carbon nanotube of the multiwalled carbon nanotubes is about 10³ S/cm.

15. The hyperspectral holographic polymer dispersed liquid crystal medium of claim 1, wherein the hyperspectral holographic polymer dispersed liquid crystal medium exhibits a switching speed between a transparent state and a reflective state on an order of microseconds.

16. The hyperspectral holographic polymer dispersed liquid crystal medium of claim 1, wherein the hyperspectral holographic polymer dispersed liquid crystal medium exhibits a switching speed between a transparent state and a reflective state on an order of nanoseconds.

17. The hyperspectral holographic polymer dispersed liquid crystal medium of claim 1, wherein the hyperspectral holographic polymer dispersed liquid crystal medium exhibits a switching speed from a transparent state to a reflective state on an order of nanoseconds.

18. The hyperspectral holographic polymer dispersed liquid crystal medium of claim 1, wherein the hyperspectral holographic polymer dispersed liquid crystal medium exhibits a switching speed from a reflective state to a transparent state on an order of microseconds.

19. The hyperspectral holographic polymer dispersed liquid crystal medium of claim 1, wherein, with an applied voltage of about 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

20. The hyperspectral holographic polymer dispersed liquid crystal medium of claim 1, wherein, with an applied voltage of less than or equal to 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

21. The hyperspectral holographic polymer dispersed liquid crystal medium of claim 1, the medium comprising a plurality of reflective gratings formed within the medium, wherein each peak reflective wavelength of the hyperspectral continuum of peak reflective wavelengths is exhibited in accordance with a respective reflective grating of the plurality of reflective gratings.

22. The hyperspectral holographic polymer dispersed liquid crystal medium of claim 21, wherein at least one of the plurality of reflective gratings is curved.

23. The hyperspectral holographic polymer dispersed liquid crystal medium of claim 22, wherein the plurality of reflective gratings reflect the hyperspectral continuum of optical energy towards a focal point.

24. The hyperspectral holographic polymer dispersed liquid crystal medium of claim 21, wherein the focal point is electrically controllable.

25. The hyperspectral holographic polymer dispersed liquid crystal medium of claim 22, wherein the medium further comprises a plurality of holographic polymer dispersed liquid crystal films arranged to form a polymeric mirror stack.

26. The hyperspectral holographic polymer dispersed liquid crystal medium of claim 22, wherein the medium further comprises a plurality of holographic polymer dispersed liquid crystal films arranged to form a polymeric filter stack.

27. The hyperspectral holographic polymer dispersed liquid crystal medium of claim 26, wherein:
each of the plurality of holographic polymer dispersed liquid crystal films reflect the hyperspectral continuum of optical energy towards a respective one of a plurality of focal points, and
the holographic polymer dispersed liquid crystal medium is further electrically controllable to switch reflection of the continuum of optical energy among the plurality of focal points.

28. The hyperspectral holographic polymer dispersed liquid crystal medium of claim 27, wherein the plurality of focal points comprise an instrument cluster.

29. A method comprising:
dynamically varying an angle of incidence between an energy beam and a film comprising a mixture of a liquid crystal. photo-polymerizable monomer, and at least one dielectric dopant throughout a range of angles between a first angle and a second angle, inclusively;
creating a plurality of interference patterns within the film, each of the plurality of interference patterns corresponding to a respective angle of the range of angles; and
photo-polymerizing the monomer with the plurality of interference patterns to form a resultant plurality of reflection gratings in the film, the resultant plurality of reflection gratings forming a hyperspectral holographic polymer dispersed liquid crystal medium that reflects a hyperspectral continuum of peak reflective wavelengths.

30. The method of claim 29, wherein the hyperspectral holographic polymer dispersed liquid crystal medium or claim 1, wherein the dielectric dopant comprises a carbon nanoparticle.

31. The method of claim 29, wherein the dielectric dopant comprises a piezoelectric nanoparticle.

32. The method of claim 29, wherein the dielectric dopant comprises a semiconductor nanoparticle.

33. The method of claim 29, wherein the dielectric dopant comprises an electrically conductive nanoparticle.

34. The method of claim 29, wherein the dielectric dopant comprises a metallic nanoparticle.

35. The method of claim 29, wherein a diameter of a droplet size of the liquid crystal is in a range of about 300 nanometers to 5 micrometers.

36. The method of claim 29, wherein the dielectric dopant comprises an anisotropy compound.

37. The method of claim 29, wherein the dielectric dopant comprises a high dielectric anisotropy compound.

38. The method of claim 29, wherein the dielectric dopant comprises thiolene-based material.

39. The method of claim 29, wherein the dielectric dopant comprises a multiwalled carbon nanotubes.

40. The method of claim 39, wherein a multiwalled carbon nanotube of the multiwalled carbon nanotubes has an outer diameter of about 20 μm.

41. The method of claim 39, wherein a multiwalled carbon nanotube of the multiwalled carbon nanotubes has a length between about 5 μm and about 10 μm.

42. The method of claim 39, wherein a conductivity of a multiwalled carbon nanotube of the multiwalled carbon nanotubes is about 10³ S/cm.

43. The method of claim 29, wherein the hyperspectral holographic polymer dispersed liquid crystal medium exhibits a switching speed between a transparent state and a reflective state on an order of microseconds.

44. The method of claim 29, wherein the hyperspectral holographic polymer dispersed liquid crystal medium exhibits a switching speed between a transparent state and a reflective state on an order of nanoseconds.

45. The method of claim 29, wherein the hyperspectral holographic polymer dispersed liquid crystal medium exhibits a switching speed from a transparent state to a reflective state on an order of nanoseconds.

46. The method of claim 29, wherein the hyperspectral holographic polymer dispersed liquid crystal medium exhibits a switching speed from a reflective state to a transparent state on an order of microseconds.

47. The method of claim 29, wherein, with an applied voltage of about 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

48. The method of claim 29, wherein, with an applied voltage of less than or equal to 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

49. The method of claim 29, wherein the angle of incidence between the energy beam and the film is dynamically varied via at least one of rotation or translation.

50. The method of claim 49, wherein the rotation or the translation is with respect to one or more elements of a holography apparatus.

51. The method of claim 50, wherein the one or more elements of the holography apparatus comprise at least one of a mirror, a beam splitter, or a sample stage.

52. The method of claim 29, further comprising:
splitting the energy beam into a plurality of energy beams;
causing the plurality of energy beams to be simultaneously incident on the film; and
dynamically varying an angle of incidence between at least one of the plurality of energy beams and the film throughout the range of angles between the first angle and the second angle, inclusively.

53. The method of claim 52, wherein at least two of the plurality of beams are counter propagating.

54. The method of claim 29, wherein the angle of incidence between the energy beam and the film is varied at least one of continuously or incrementally during a photo-polymerization interval.

55. The method of claim 29, wherein the plurality of interference patterns is created using a prism.

56. The method of claim 29, wherein the plurality of interference patterns is created using a mirror.

57. The method of claim 29, wherein the plurality of interference patterns is created using a filter.

58. An apparatus comprising:
an energy beam source for creating a plurality of interference patterns within a hyperspectral holographic polymer dispersed liquid crystal medium comprising at least one dielectric dopant;
a sample stage for supporting the hyperspectral holographic polymer dispersed liquid crystal medium; and
at least one dynamically positionable element configured to vary an angle of incidence between an energy beam generated by the energy beam source and a surface of the holographic polymer dispersed liquid crystal medium, thereby causing the plurality of interference patterns to form a plurality of reflection gratings in the hyperspectral holographic polymer dispersed liquid crystal medium that reflect reflects a hyperspectral continuum of multiple wavelengths of optical energy within a spectrum.

59. The apparatus of claim 58, wherein the dielectric dopant comprises a carbon nanoparticle.

60. The apparatus of claim 58, wherein the dielectric dopant comprises a piezoelectric nanoparticle.

61. The apparatus of claim 58, wherein the dielectric dopant comprises a semiconductor nanoparticle.

62. The apparatus of claim 58, wherein the dielectric dopant comprises an electrically conductive nanoparticle.

63. The apparatus of claim 58, wherein the dielectric dopant comprises a metallic nanoparticle.

64. The apparatus of claim 58, wherein a diameter of a droplet size of the liquid crystal is in a range of about 300 nanometers to 5 micrometers.

65. The apparatus of claim 58, wherein the dielectric dopant comprises an anisotropy compound.

66. The apparatus of claim 58, wherein the dielectric dopant comprises a high dielectric anisotropy compound.

67. The apparatus of claim 58, wherein the dielectric dopant comprises thiolene-based material.

68. The apparatus of claim 58, wherein the dielectric dopant comprises a multiwalled carbon nanotubes.

69. The apparatus of claim 68, wherein a multiwalled carbon nanotube of the multiwalled carbon nanotubes has an outer diameter of about 20 μm.

70. The apparatus of claim 68, wherein a multiwalled carbon nanotube of the multiwalled carbon nanotubes has a length between about 5 μm and about 10 μm.

71. The apparatus of claim 68, wherein a conductivity of a multiwalled carbon nanotube of the multiwalled carbon nanotubes is about 10³ S/cm.

72. The apparatus of claim 58, wherein the hyperspectral holographic polymer dispersed liquid crystal medium exhibits a switching speed between a transparent state and a reflective state on an order of microseconds.

73. The apparatus of claim 58, wherein the hyperspectral holographic polymer dispersed liquid crystal medium exhibits a switching speed between a transparent state and a reflective state on an order of nanoseconds.

74. The apparatus of claim 58, wherein the hyperspectral holographic polymer dispersed liquid crystal medium exhibits a switching speed from a transparent state to a reflective state on an order of nanoseconds.

75. The apparatus of claim 58, wherein the hyperspectral holographic polymer dispersed liquid crystal medium exhibits a switching speed from a reflective state to a transparent state on an order of microseconds.

76. The apparatus of claim 58, wherein, with an applied voltage of about 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

77. The apparatus of claim 58, wherein, with an applied voltage of less than or equal to 400 volts, the hyperspectral holographic polymer dispersed liquid crystal medium exhibits:
a switching speed from a reflective state to a transparent state of 15 microseconds; and
a switching speed from a transparent state to a reflective state of 100 nanoseconds.

78. The apparatus of claim 58, wherein the sample stage is a dynamically positionable sample stage configured to vary the angle of incidence between the laser beam and a surface of the holographic polymer dispersed liquid crystal medium.

79. The apparatus of claim 78, wherein the dynamically positionable sample stage is dynamically positionable via at least one of rotation or translation of the dynamically positionable sample stage.

80. The apparatus of claim 58, wherein the at least one dynamically positionable element is configured for at least one of translation of the dynamically positionable element or rotation of the dynamically positionable element.
